(19) United States
(12) Patent Application Publication
(10) Pub. No.: US 2022/0414521 A1
(43) Pub. Date: Dec. 29, 2022

(54) AUTOMATED MACHINE LEARNING MODEL TRANSFORMATION USING ARTIFICIAL INTELLIGENCE

(71) Applicant: International Business Machines Corporation, Armonk, NY (US)

(72) Inventor: Chun Lei Xu, Xian (CN)

(21) Appl. No.: 17/304,694

(22) Filed: Jun. 24, 2021

(51) Int. Cl. G06N 20/00

(52) U.S. Cl. CPC G06N 20/00

(57) ABSTRACT

A computer transforms a machine learning model. The computer receives a first Machine Learning model trained to assign a first set of classes to data samples based, on data features. The computer receives a first set of data samples having features and being assigned to a class in accordance with the features. The computer calculates for each data sample, a vector representing features of the sample and determines, for each of the first set of classes, a class largest intra-sample distance. The computer generates data samples having feature combinations outside the first set of classes. The computer transforms the first Machine Learning model into a second Machine Learning model by training the first Machine Learning model with training data including second set data samples labeled with associated second data class assignments.

### BACKGROUND

The present invention relates generally to the field of Artificial Intelligence (AI), and more specifically, to machine learning models.

In Machine Learning (ML), models are trained and then utilized for prediction (e.g., data classification modeling). ML models are trained to recognize features and patterns of a relevant training dataset. In some cases, additional datasets received for classification may represent patterns beyond those present when a given ML model was trained. In situations where data present patterns that are beyond the range of patterns shown in training examples, the associated model may perform poorly when attempting to classify the new data.

### SUMMARY

According to one embodiment, a computer-implemented method of transforming a machine learning model includes, receiving by a computer, from a model source available to the computer, a first Machine Learning model trained to assign one of a first set of classes to received data samples based, at least in part on sets of feature group values associated with each of the data samples. The computer receives from a data source available to the computer, a first set of data samples each characterized by an associated set of feature group values and assigned to one the first set of classes in accordance, at least in part, therewith. The computer calculates for each of the first set of data samples, a vector representing a respective set of feature group values associated with each data sample and determining, for each of the first set of classes, a largest class sample distance between all of the first set of data samples assigned to the class. The computer generates a second set of data samples each characterized by a set of feature group values for which an associated calculated vector has an associated smallest distance from all other data samples in the first set of data samples exceeding all of the largest class sample distances and assigning each of the second set of data samples to one of a second set of classes each different from the first set of classes. The computer transforms the first Machine Learning model into a second Machine Learning model by training the first Machine Learning model with training data including second set data samples labeled with associated second data class assignments. According to aspects of the invention, the computer, in response to receiving a third set of data samples having a quantity above a predetermined threshold for which an associated calculated vector has an associated smallest distance from all other data samples in the first and second sets of data samples that exceeds all of the largest class sample distances, initiates at least one corrective action. According to aspects of the invention, the at least one corrective action includes sending an alert to a user interface operatively connected to the computer. According to aspects of the invention, the at least one corrective action includes: assigning each of the third set of data samples to one of a third set of classes each different from the first and second sets of classes; and transforming, by the computer, the second ML model into a third ML model by training the second ML with training data including third set data samples labeled with associated third data class assignments. According to aspects of the invention, the second set of classes includes a maximum quantity of classes based, at least in part on a second class quantity maximum value received by the computer from a quantity maximum value source available to the computer. According to aspects of the invention, the class sample distances are calculated based on a measurement technique selected from the group consisting of Euclidean distance, dot product, and cosine similarity. According to aspects of the invention, the feature group values are generated, at least in part, by application of a binning operation to a feature characterized by a substantially-continuous range.

According to another embodiment, a system to transform a machine learning model, includes: a computer system comprising a computer readable storage medium having program instructions embodied therewith, the program instructions executable by a computer to cause the computer to: receive from a model source available to the computer, a first Machine Learning model trained to assign one of a first set of classes to received data samples based, at least in part on sets of feature group values associated with each of the data samples; receive from a data source available to the computer, a first set of data samples each characterized by an associated set of feature group values and assigned to one the first set of classes in accordance, at least in part, therewith; calculate for each of the first set of data samples, a vector representing a respective set of feature group values associated with each data sample and determining, for each of the first set of classes, a largest class sample distance between all of the first set of data samples assigned to the class; generate a second set of data samples each characterized by a set of feature group values for which an associated calculated vector has an associated smallest distance from all other data samples in the first set of data samples exceeding all of the largest class sample distances and assigning each of the second set of data samples to one of a second set of classes each different from the first set of classes; transform the first Machine Learning model into a second Machine Learning model by training the first Machine Learning model with training data including second set data samples labeled with associated second data class assignments.

According to another embodiment, a computer program product to transform a machine learning model, the computer program product comprising a computer readable storage medium having program instructions embodied therewith, the program instructions executable by a computer to cause the computer to: receive, using the computer, from a model source available to the computer, a first Machine Learning model trained to assign one of a first set of classes to received data samples based, at least in part on sets of feature group values associated with each of the data samples; receive, using the computer, from a data source available to the computer, a first set of data samples each characterized by an associated set of feature group values and assigned to one the first set of classes in accordance, at least in part, therewith; calculate, using the computer, for each of the first set of data samples, a vector representing a respective set of feature group values associated with each data sample and determining, for each of the first set of classes, a largest class sample distance between all of the first set of data samples assigned to the class; generate, using the computer, a second set of data samples each characterized by a set of feature group values for which an associated calculated vector has an associated smallest distance from all other data samples in the first set of data samples exceeding all of the largest class sample distances and assigning each of the second set of data samples to one of a second set of classes each different from the first set of classes; transform, using the computer, the first Machine Learning model into a second Machine Learning model by training the first Machine Learning model with training data including second set data samples labeled with associated second data class assignments.

The present disclosure recognizes and addresses the shortcomings and problems associated with accurately predicting patterns for data representing feature patterns beyond those for which the model has been trained.

Aspects of the present invention maintain prediction accuracy (e.g., classification) for data having feature combinations not represented in original training data. In an embodiment, the present invention accurately identifies financial transactions that represent new feature combinations, classifies them correctly, and generates alerts as appropriate.

Aspects of the present invention analyze the probability of the training dataset feature values combinations, generate data with feature combinations having a lower probability of occurring than feature combinations (e.g., data distributions) of the training data, and then update (e.g., retrain) the original model to correctly classify the new data.

Aspects of the present invention will adapt to classify future incoming data not part of the training data scope. In an embodiment, aspects of the present invention will recognize when newly-received data is very different from training data (e.g., based on automatically calculated original class similarity thresholds). Aspects of the present invention will identify such data with associated labels. In an embodiment, an original model will be transformed (e.g. retrained and updated) to accommodate data with new (e.g., beyond the scope of training data) feature combinations. Aspects of the present invention respond to new data patterns overcome model and address update lag issues associated with time-based, periodic model updating.

Aspects of the present invention transform feature value groups into vectors, generate feature value groups, and calculate (e.g., by a neural network) vectors of each feature value group.

Aspects of the present invention generate data with novel (e.g., not modelled) feature value combination patterns and provide associated labels. In an embodiment, aspects of the present invention calculate maximum vector distances for each initial data class, generate samples with larger vector distances (e.g., samples that are outside of original classes), generates samples in several new classes, and provides associated labels for data samples in each new data class.

Aspects of the present invention classifies new data, notes a quantity of data having a new label (e.g., not present in the original set of labels), and generates and initiates a corrective action (e.g., generates an alert or updates the model) when the noted quantity of new labels exceeds a predetermined threshold.

### BRIEF DESCRIPTION OF THE DRAWINGS

These and other objects, features and advantages of the present invention will become apparent from the following detailed description of illustrative embodiments thereof, which is to be read in connection with the accompanying drawings. The various features of the drawings are not to scale as the illustrations are for clarity in facilitating one skilled in the art in understanding the invention in conjunction with the detailed description. The drawings are set forth as below as:

FIG. 1 is a schematic block diagram illustrating an overview of a system for computer-implemented transformation of machine learning models to classify data samples outside of initially-established classes according to embodiments of the present invention.

FIG. 2 is a flowchart illustrating a method, implemented using the system shown in FIG. 1, of transforming machine learning models to classify data samples outside of initially-established classes according to embodiments of the present invention.

FIG. 3 is a flowchart illustrating aspects of a method, implemented using the system shown in FIG. 1, of transforming machine learning models to classify data samples outside of initially-established classes according to embodiments of the present invention.

FIG. 4A is a table showing representative aspects of data received for use with aspects of the system shown in FIG. 1, for transforming machine learning models to classify data samples outside of initially-established classes according to embodiments of the present invention.

FIG. 4B is a table showing representative aspects of data received for use with aspects of the system shown in FIG. 1, for transforming machine learning models to classify data samples outside of initially-established classes according to embodiments of the present invention.

FIG. 5 is a schematic representation of aspects of data received for use with the system shown in FIG. 1, for transforming machine learning models to classify data samples outside of initially-established classes according to embodiments of the present invention.

FIG. 6 is a schematic representation of aspects of data received for use with the system shown in FIG. 1, for transforming machine learning models to classify data samples outside of initially-established classes according to embodiments of the present invention.

FIG. 7 is a table showing aspects of revised training data used by aspects of the system shown in FIG. 1, for transforming machine learning models to classify data samples outside of initially-established classes according to embodiments of the present invention.

FIG. 8 is a schematic block diagram depicting a computer system according to an embodiment of the disclosure which may be incorporated, all or in part, in one or more computers or devices shown in FIG. 1, and cooperates with the systems and methods shown in FIG. 1.

FIG. 9 depicts a cloud computing environment according to an embodiment of the present invention.

FIG. 10 depicts abstraction model layers according to an embodiment of the present invention.

### DETAILED DESCRIPTION

The following description with reference to the accompanying drawings is provided to assist in a comprehensive understanding of exemplary embodiments of the invention as defined by the claims and their equivalents. It includes various specific details to assist in that understanding but these are to be regarded as merely exemplary. Accordingly, those of ordinary skill in the art will recognize that various changes and modifications of the embodiments described herein can be made without departing from the scope and spirit of the invention. In addition, descriptions of well-known functions and constructions may be omitted for clarity and conciseness.

The terms and words used in the following description and claims are not limited to the bibliographical meanings, but, are merely used to enable a clear and consistent understanding of the invention. Accordingly, it should be apparent to those skilled in the art that the following description of exemplary embodiments of the present invention is provided for illustration purpose only and not for the purpose of limiting the invention as defined by the appended claims and their equivalents.

It is to be understood that the singular forms “a,” “an,” and “the” include plural referents unless the context clearly dictates otherwise. Thus, for example, reference to “a participant” includes reference to one or more of such participants unless the context clearly dictates otherwise.

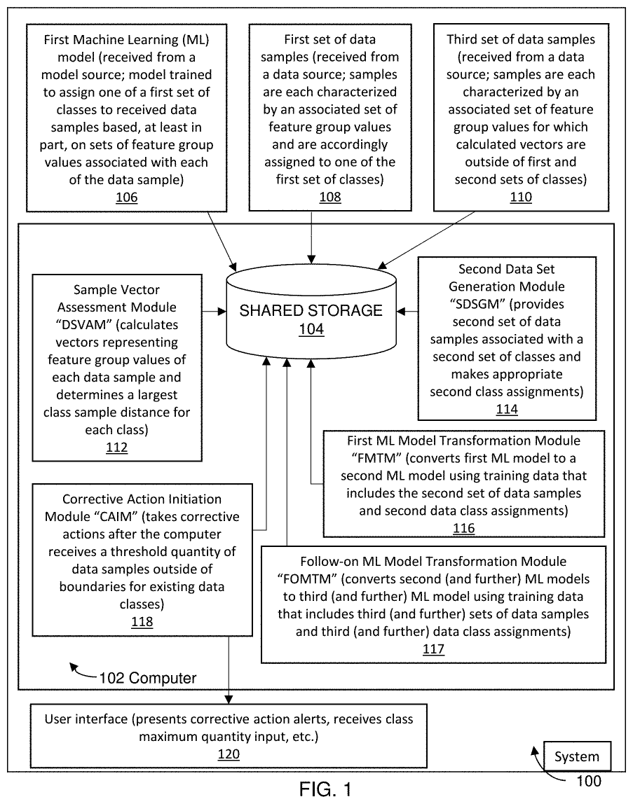

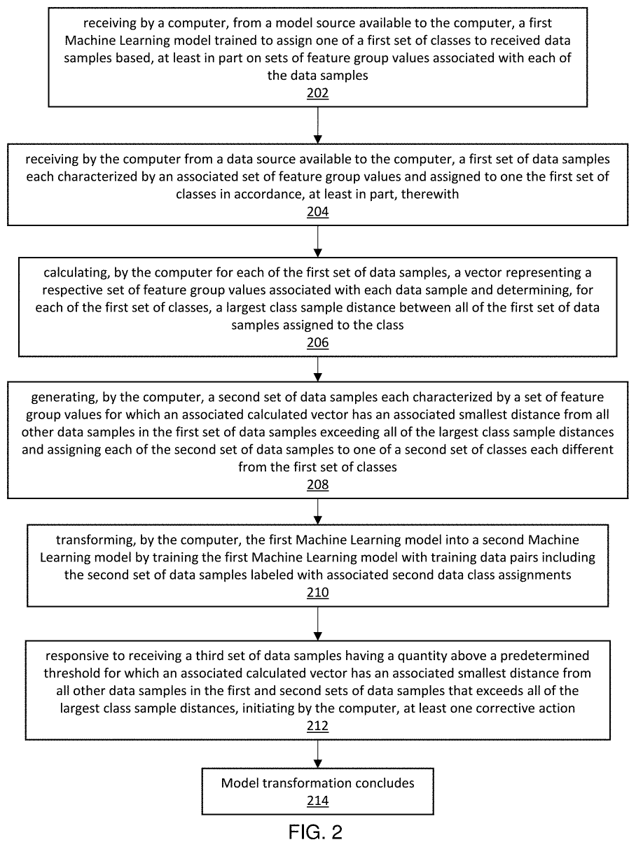

Now with combined reference to the Figures generally and with particular reference to FIG. 1 and FIG. 2, an overview of a method for transforming machine learning models to classify data samples outside of initially-established classes usable within a system 100 as carried out by a server computer 102 having optionally shared storage 104.

The server computer 102 receives a First Machine Learning (ML) model 106 from a model source available to the server computer. According to aspects of the invention, the model is trained to assign one of a first set of classes to received data samples based, at least in part, on sets of feature group values associated with each of the data samples.

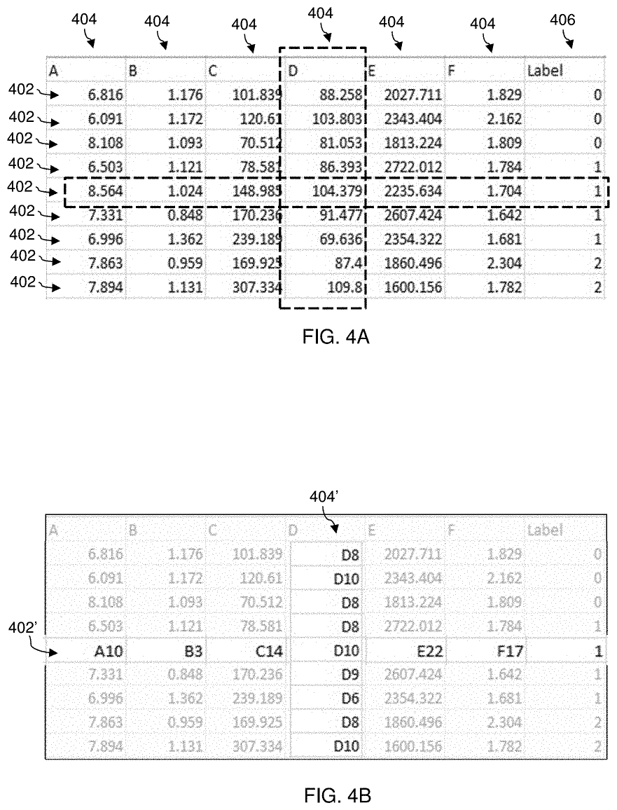

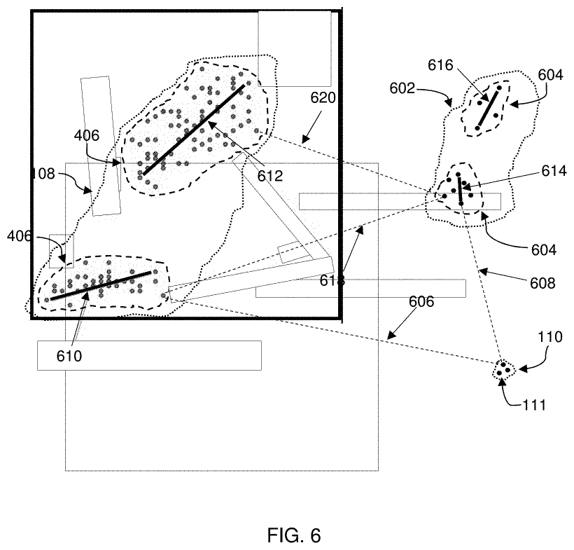

The server computer 102 receives a first set of data samples 108 from a data source available to the server computer. According to aspects of the invention, each of the first set 108 of samples is characterized by an associated set 402 of feature group values 404 (e.g., as shown in FIG. 4A). According to aspects of the invention, each of the first data samples is associated with one of a first set of classes 406 (e.g., indicated within the “Label” column shown in in FIG. 4A and as shown schematically, as a first set of data samples 108 located within with one of a first set of classes 406, in FIG. 6). It is noted that although FIG. 4A shows classes “0”, “1”, and “2”, only two of the first set of classes 406 are depicted in FIG. 6.

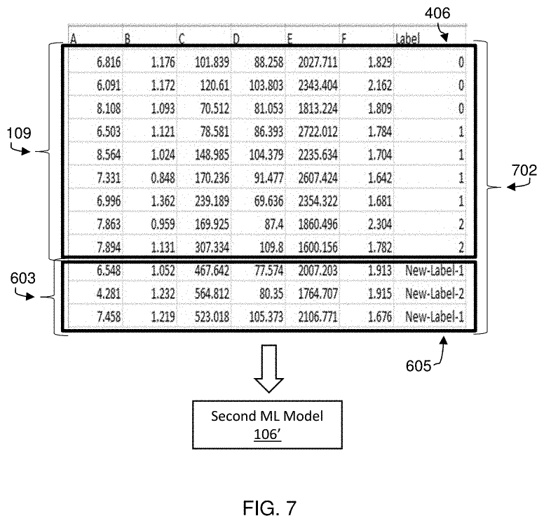

As will be discussed more fully below, the server computer 102 generates a second set of data samples 602 (shown, e.g., in FIG. 6). In an embodiment, each of the second set of data samples is associated with a class in a second set of classes 604. According to aspects of the invention, samples in the second set of data samples 602 are used as training data to transform the first ML model 106 into a second machine learning model 106′ (shown, e.g., in FIG. 7). In an embodiment, the training data.

The server computer 102 receives a third set of data samples 110 from a data source available to the server computer. According to aspects of the invention, each of the third set of samples is characterized by an associated set of feature group values (not shown) for which a calculated vector is located outside of the first and second sets of data samples 108, 602 (as shown, e.g., in FIG. 6). More particularly, according to aspects of the invention, members of the third set of data samples 110 will have a calculated sample vector that has a shortest distance 606 to closest members of the first set of data 108 that is longer than the largest sample distances 610, 612 associated with the classes 406 of the first data set 108. According to aspects of the invention, the members of the third set of data samples 110 will also have a calculated sample vector that has a shortest distance 608 to closest members of the second set of data 602 that is longer than the largest sample distances 614, 616 associated with the classes 604 of the second data set 602.

The server computer 102 includes Sample Vector Assessment Module “DSVAM” 112 that calculates vectors representing feature group values of each data sample. According to aspects of the invention, the DSVAM 112 determines first set of largest class sample distances 610, 612 for classes 406 associated with the first set of data samples 108 (as represented, e.g., in FIG. 6). In an embodiment, the first set of largest class sample distances 610, 612 represent the largest spans between samples in the respective first set of data sample classes 406. According to aspects of the invention, the DSVAM 112 determines second set of largest class sample distance 614, 616 for classes 604 associated with the second set of data samples 602 (as represented, e.g., in FIG. 6). In an embodiment, the second set of largest class sample distances 614, 616 represent the largest spans between samples in the respective second set of data sample classes 604.

The server computer 102 includes Second Data Set Generation Module “SDSGM” 114 that provides second set of data samples 602 having feature group values 404 associated with a second set of classes 604. According to aspects of the invention, the SDSGM 114 assigns each of the data samples in the second data sample set 602 to one of the second set of classes 604.

The server computer 102 includes First ML Model Transformation Module “FMTM” 116 that converts the first ML model 106 to a second ML model 106′ (as shown, e.g., in FIG. 7) using compound training data 702 that, in addition to previously applied first set of training data 109 (e.g., a portion selected from the first set of sample data 108), includes a training data portion 603 of the second set of data samples identified with associated second data class assignment labels 605.

The server computer 102 includes Second First ML Model Transformation Module “FMTM” 116 that converts the first ML model 106 to a second ML model 106′ (as shown, e.g., in FIG. 7) using compound training data 702 that, in addition to a previously applied first set of training data 109, includes a second set 603 of training data selected from the second set of data samples 602 labeled with the second data class assignments 602.

The server computer 102 includes Corrective Action Initiation Module “CAIM” 118 that takes corrective actions after the server computer 102 receives a threshold quantity of data samples outside of boundaries for existing data classes. It is noted that data samples with feature group value combinations beyond ranges of those previously learned (e.g., beyond those represented by data encountered during model training) are best classified by models updated to consider the new feature combinations, and aspects of the invention address this. In an embodiment, the CAIM 118 will send and alert (e.g., to a user interface 120) or initiate model retraining with training data updated to represent new classifications (e.g., as shown schematically in FIG. 7).

Now with specific reference to FIG. 2, and to other figures generally, a computer-implemented method of transforming machine learning models to classify data samples outside of initially-established classes with the system 100 will be discussed. The server computer 102 at block 202 receives, from a model source available to the computer, a first Machine Learning (ML) model 106 trained to assign one of a first set of classes 406 to received data samples 108 based, at least in part on sets 402 (e.g., tabular rows in FIG. 4A) of feature group values 404 (e.g., tabular columns in FIG. 4A) associated with each of the data samples.

The server computer 102 receives at block 204 from a data source available to the computer, a first set of data samples 108 each characterized by an associated set 402 of feature group values 404. In an embodiment, the first set of data samples 108 are assigned to one the first set of classes 406 in accordance with the set 402 of feature values associated with the sample.

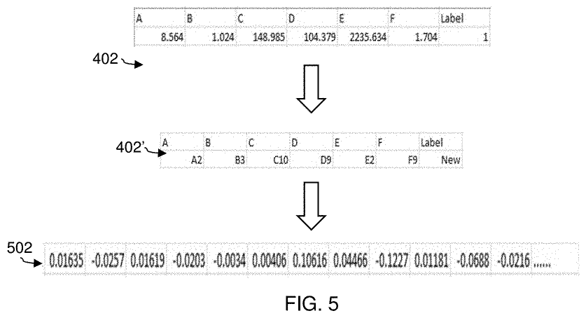

The server computer 102 via Sample Vector Assessment Module “DSVAM” 112 at block 206 calculates (e.g., via multi-layer neural network, or other method selected by one of skill in this field), for each of the first set of data samples, a vector 502 (e.g., a sample-representing numerical feature embedding, as shown schematically in FIG. 5) associated with a respective set 402 of feature group values 404 (as shown, e.g., in FIG. 4A) associated with each data sample. According to aspects of the invention, the DSVAM 112 calculates sample vector differences between each pair of samples (e.g., considering Cosine similarity, Euclidean distances, or by some other method selected by one of skill in this field). In an embodiment, the DSVAM 112 identifies for each of the first set of classes 406, a respective largest class sample distance 610, 612. In an embodiment, each category for categorical features associated with a given data sample will be treated as an individual group, a group embedding vector will be calculated for each category. In an in which sample features are substantially-continuous feature, the range (e.g., a [MIN,MAX]) will be separated by methods known to those of skill in this field (e.g., by bucketing, binning, etc.) into preferred groups 404′ (e.g., as shown in FIG. 4B). Once the groups are determined, the original values 402 in dataset is replaced with the group labels 402′ (e.g., as shown schematically in FIG. 5). For example, with reference to FIG. 4B, a feature “D” having a range [0.000, 200.000] could be divided (e.g., binned or otherwise divided) into multiple (e.g., 20) groups: D1: [0, 10), D2: [10, 20), . . . D20 [190, 200] to provide “n” groups (e.g., D1, D2 . . . Dn). According to aspects of the invention, each set of feature value 402 can be transformed into a new dataset 402′ representing the binned feature value groups 404′, and the group value range is stored by the DSVAM 112 for later processing. According to aspects of the invention, the DSVAM 114 transforms feature value groups into a vector representing the feature group.

The server computer 102 via Second Data Set Generation Module “SDSGM” 114 generates at block 208 a second set of data samples 602 each characterized by a set of feature group values for which an associated calculated vector has associated smallest distances 618,620 from all other data samples in the first set 108 of data samples exceeding all of the first data set largest class sample distances 610, 612 (e.g., for each class within the first set of sample data 108). In an embodiment, the SDSGM 114 assigns each of the second set 602 of data samples to one of a second set of classes each different from the first set of classes (e.g., by clustering methods, K-nearest neighbors algorithms, or other grouping method selected by one skilled in this field). In an embodiment, the quantity of classes in the second set of classes is limited by a second class quantity maximum value received by the computer (e.g., from a user interface input, retrieved from storage, or through another method selected by one skilled in this field). In an embodiment shown in FIG. 6, the second class quantity maximum value is two. According to aspects of the present invention, the SDSGM 114 generates a second set of data with new feature patterns (e.g., sets of feature value groups) not represented by samples in the first data set 108, resulting in training data used (as described more fully below) to transform the first ML model 106 into a second, enhanced ML model 106′ with enhanced classification ability. In an embodiment, SDSGM 114 generates second data samples 602 iteratively by collecting groups of previously-existing feature values 404 in a substantially-random fashion to form set 402′ and generating second sample candidates characterized by assorted sets of feature values 404. The SDSGM 114 calculates (e.g., via a layered neural network or similar method selected by one skilled in this field) sample vectors for each second sample candidate and calculates a shortest distance 618,620 to the data samples in each class 406 of the first set 108 of sample data, and candidates with a shortest vector distance to data samples in each class longer that the largest sample difference 610,612 for classes associated with the first set of sample data 108 are selected as members of the second set of data samples 602.

The server computer 102 via First ML Model Transformation Module “FMTM” 116 at block 210 transforms the first Machine Learning model 106 into a second Machine Learning model 106′ by training the first Machine Learning model 106 with compound training data 702 that, in addition to original training data 108 from the first set of sample data (e.g., a training portion of the first set of data samples), includes training data 603 from the second set of sample data 602 having samples with associated second data class assignment label 605. According to aspects of the invention, once trained with the compound training data 702, the transformed ML model 106′ can be verified with evaluation data (not shown) and fined tuned as necessary. According to aspects of the present invention, the transformed model 106′ will, when compared to the first ML model 106, make more accurate classifications when presented with data similar to samples 602 in the second set of data, providing a model 106′ with enhanced classification performance.

The server computer 102, via Corrective Action Initiation Module “CAIM” 118 at block 212, in response to receiving a third set of data samples 110 having a quantity above a predetermined threshold for which an associated calculated vector has an associated smallest distance from all other data samples in the first and second sets of data samples that exceeds all of the largest class sample vector distances (calculated in a fashion similar to that described previously), initiating by the computer, at least one corrective action. In an embodiment, the predetermined threshold is 10 samples. However, other values (e.g., including other pre-set values and values based on quantity of samples in the first and second sets of data samples 108,602 may also be selected by one skilled in this field).

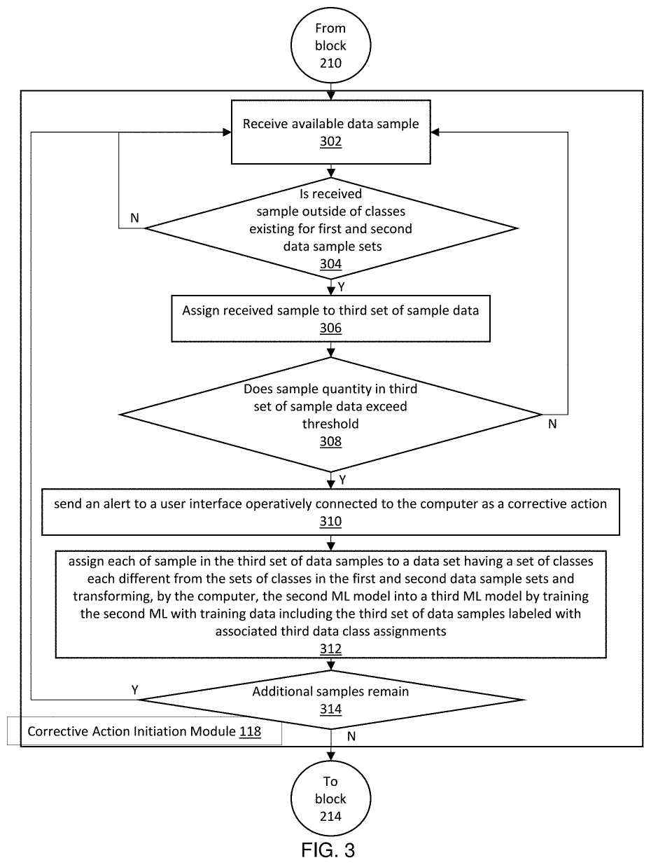

Now with reference to FIG. 3, aspects of a method to initiate corrective action according to an embodiment of the present invention is shown. The server computer 102 receives a data sample at block 302. The server computer 102 via Corrective Action Initiation Module “CAIM” 118 at block 304 determines whether the received sample is outside of classes 406, 604 existing for first and second data sample sets 108,602. In particular, the CAIM 118 calculates a vector embedding for the sample and determines whether a shortest vector distance 606,608 between the sample and closest sample from existing first and second sample sets 108, 602 is longer that the largest sample distances 610, 610 and 614,616 for each of the classes 406,604. If the received sample is not outside of the first and second sample data set classes 406,604, flow returns to block 302, and another available sample may be collected.

If the shortest vector distance 606,608 are longer than the largest sample distances 610, 610 and 614,616 for each of the classes 406,604, the CAIM 118 identifies the received sample as being outside of the first and second sample sets 108, 602, and flow continues to block 306, where CAIM 118 places the sample into the third sample data set 110.

The server computer 102, via CAIM 118 determines whether the quantity of samples in third set of sample data exceeds a predetermined action threshold. In an embodiment, the predetermined corrective action threshold is 10 samples. However, other values (e.g., including other larger or smaller pre-set values and values based on quantity of samples in the first and second sets of data samples 108,602 may also be selected by one skilled in this field). If the third set quantity equals (or is below) the corrective action threshold, flow returns to block 302, and the CAIM receives another available data sample. When the third set quantity exceeds the corrective action threshold, the CAIM 118 initiates at least one corrective action.

In an embodiment, the server computer 102 via CAIM 118 at block 310 sends an alert to a user interface 120 as a corrective action, and flow continues to block 310.

In an embodiment, the server computer 102 via CAIM 118 at block 312 assigns each of the received samples determined to be outside of the first and second sets of data 110, 602 to a data set 110 having a set of classes 111 each different from the sets of classes 406, 602 in the first and second data sample sets and transforming via Follow-on ML Model Transformation Module “FOMTM” 117, the second ML model 106′ into a third ML model (not shown) by training the second ML model 106′ with training data including a third set of training data samples labeled with associated third data class assignments 111.

The server computer 102 via CAIM 118 at block 314 returns flow control to block 302 to process additional samples, if any remain. If no additional samples are available for processing, flow returns to block 214 and model transformation concludes.

Regarding the flowcharts and block diagrams, the flowchart and block diagrams in the Figures of the present disclosure illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

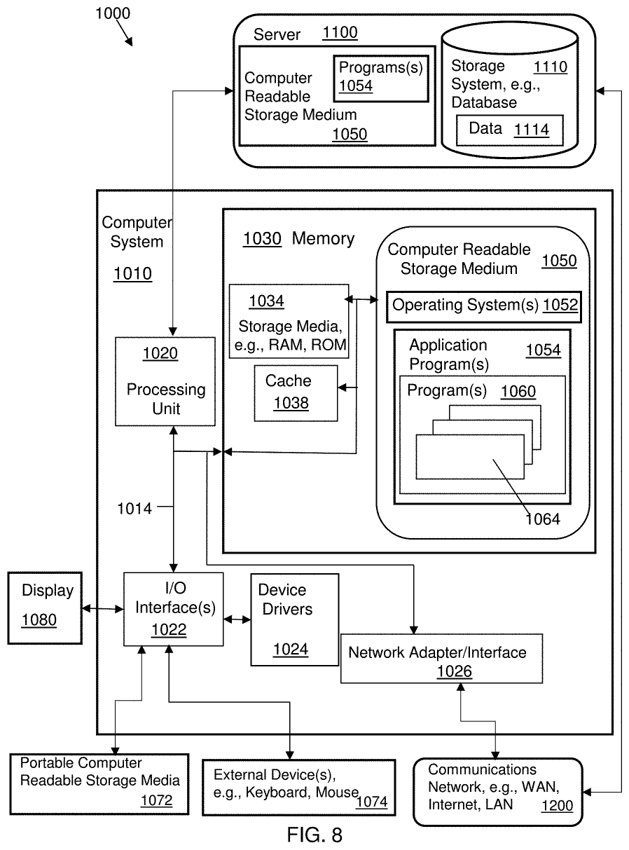

Referring to FIG. 8, a system or computer environment 1000 includes a computer diagram 1010 shown in the form of a generic computing device. The method of the invention, for example, may be embodied in a program 1060, including program instructions, embodied on a computer readable storage device, or computer readable storage medium, for example, generally referred to as memory 1030 and more specifically, computer readable storage medium 1050. Such memory and/or computer readable storage media includes non-volatile memory or non-volatile storage. For example, memory 1030 can include storage media 1034 such as RAM (Random Access Memory) or ROM (Read Only Memory), and cache memory 1038. The program 1060 is executable by the processor 1020 of the computer system 1010 (to execute program steps, code, or program code). Additional data storage may also be embodied as a database 1110 which includes data 1114. The computer system 1010 and the program 1060 are generic representations of a computer and program that may be local to a user, or provided as a remote service (for example, as a cloud based service), and may be provided in further examples, using a website accessible using the communications network 1200 (e.g., interacting with a network, the Internet, or cloud services). It is understood that the computer system 1010 also generically represents herein a computer device or a computer included in a device, such as a laptop or desktop computer, etc., or one or more servers, alone or as part of a datacenter. The computer system can include a network adapter/interface 1026, and an input/output (I/O) interface(s) 1022. The I/O interface 1022 allows for input and output of data with an external device 1074 that may be connected to the computer system. The network adapter/interface 1026 may provide communications between the computer system a network generically shown as the communications network 1200.

The computer 1010 may be described in the general context of computer system-executable instructions, such as program modules, being executed by a computer system. Generally, program modules may include routines, programs, objects, components, logic, data structures, and so on that perform particular tasks or implement particular abstract data types. The method steps and system components and techniques may be embodied in modules of the program 1060 for performing the tasks of each of the steps of the method and system. The modules are generically represented in the figure as program modules 1064. The program 1060 and program modules 1064 can execute specific steps, routines, sub-routines, instructions or code, of the program.

The method of the present disclosure can be run locally on a device such as a mobile device, or can be run a service, for instance, on the server 1100 which may be remote and can be accessed using the communications network 1200. The program or executable instructions may also be offered as a service by a provider. The computer 1010 may be practiced in a distributed cloud computing environment where tasks are performed by remote processing devices that are linked through a communications network 1200. In a distributed cloud computing environment, program modules may be located in both local and remote computer system storage media including memory storage devices.

The computer 1010 can include a variety of computer readable media. Such media may be any available media that is accessible by the computer 1010 (e.g., computer system, or server), and can include both volatile and non-volatile media, as well as, removable and non-removable media. Computer memory 1030 can include additional computer readable media in the form of volatile memory, such as random access memory (RAM) 1034, and/or cache memory 1038. The computer 1010 may further include other removable/non-removable, volatile/non-volatile computer storage media, in one example, portable computer readable storage media 1072. In one embodiment, the computer readable storage medium 1050 can be provided for reading from and writing to a non-removable, non-volatile magnetic media. The computer readable storage medium 1050 can be embodied, for example, as a hard drive. Additional memory and data storage can be provided, for example, as the storage system 1110 (e.g., a database) for storing data 1114 and communicating with the processing unit 1020. The database can be stored on or be part of a server 1100. Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each can be connected to bus 1014 by one or more data media interfaces. As will be further depicted and described below, memory 1030 may include at least one program product which can include one or more program modules that are configured to carry out the functions of embodiments of the present invention.

The method(s) described in the present disclosure, for example, may be embodied in one or more computer programs, generically referred to as a program 1060 and can be stored in memory 1030 in the computer readable storage medium 1050. The program 1060 can include program modules 1064. The program modules 1064 can generally carry out functions and/or methodologies of embodiments of the invention as described herein. The one or more programs 1060 are stored in memory 1030 and are executable by the processing unit 1020. By way of example, the memory 1030 may store an operating system 1052, one or more application programs 1054, other program modules, and program data on the computer readable storage medium 1050. It is understood that the program 1060, and the operating system 1052 and the application program(s) 1054 stored on the computer readable storage medium 1050 are similarly executable by the processing unit 1020. It is also understood that the application 1054 and program(s) 1060 are shown generically, and can include all of, or be part of, one or more applications and program discussed in the present disclosure, or vice versa, that is, the application 1054 and program 1060 can be all or part of one or more applications or programs which are discussed in the present disclosure.

One or more programs can be stored in one or more computer readable storage media such that a program is embodied and/or encoded in a computer readable storage medium. In one example, the stored program can include program instructions for execution by a processor, or a computer system having a processor, to perform a method or cause the computer system to perform one or more functions.

The computer 1010 may also communicate with one or more external devices 1074 such as a keyboard, a pointing device, a display 1080, etc.; one or more devices that enable a user to interact with the computer 1010; and/or any devices (e.g., network card, modem, etc.) that enables the computer 1010 to communicate with one or more other computing devices. Such communication can occur via the Input/Output (I/O) interfaces 1022. Still yet, the computer 1010 can communicate with one or more networks 1200 such as a local area network (LAN), a general wide area network (WAN), and/or a public network (e.g., the Internet) via network adapter/interface 1026. As depicted, network adapter 1026 communicates with the other components of the computer 1010 via bus 1014. It should be understood that although not shown, other hardware and/or software components could be used in conjunction with the computer 1010. Examples, include, but are not limited to: microcode, device drivers 1024, redundant processing units, external disk drive arrays, RAID systems, tape drives, and data archival storage systems, etc.

It is understood that a computer or a program running on the computer 1010 may communicate with a server, embodied as the server 1100, via one or more communications networks, embodied as the communications network 1200. The communications network 1200 may include transmission media and network links which include, for example, wireless, wired, or optical fiber, and routers, firewalls, switches, and gateway computers. The communications network may include connections, such as wire, wireless communication links, or fiber optic cables. A communications network may represent a worldwide collection of networks and gateways, such as the Internet, that use various protocols to communicate with one another, such as Lightweight Directory Access Protocol (LDAP), Transport Control Protocol/Internet Protocol (TCP/IP), Hypertext Transport Protocol (HTTP), Wireless Application Protocol (WAP), etc. A network may also include a number of different types of networks, such as, for example, an intranet, a local area network (LAN), or a wide area network (WAN).

In one example, a computer can use a network which may access a website on the Web (World Wide Web) using the Internet. In one embodiment, a computer 1010, including a mobile device, can use a communications system or network 1200 which can include the Internet, or a public switched telephone network (PSTN) for example, a cellular network. The PSTN may include telephone lines, fiber optic cables, transmission links, cellular networks, and communications satellites. The Internet may facilitate numerous searching and texting techniques, for example, using a cell phone or laptop computer to send queries to search engines via text messages (SMS), Multimedia Messaging Service (MMS) (related to SMS), email, or a web browser. The search engine can retrieve search results, that is, links to websites, documents, or other downloadable data that correspond to the query, and similarly, provide the search results to the user via the device as, for example, a web page of search results.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be accomplished as one step, executed concurrently, substantially concurrently, in a partially or wholly temporally overlapping manner, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

It is to be understood that although this disclosure includes a detailed description on cloud computing, implementation of the teachings recited herein are not limited to a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g., networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported, providing transparency for both the provider and consumer of the utilized service.

Service Models are as follows:

Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure that includes a network of interconnected nodes.

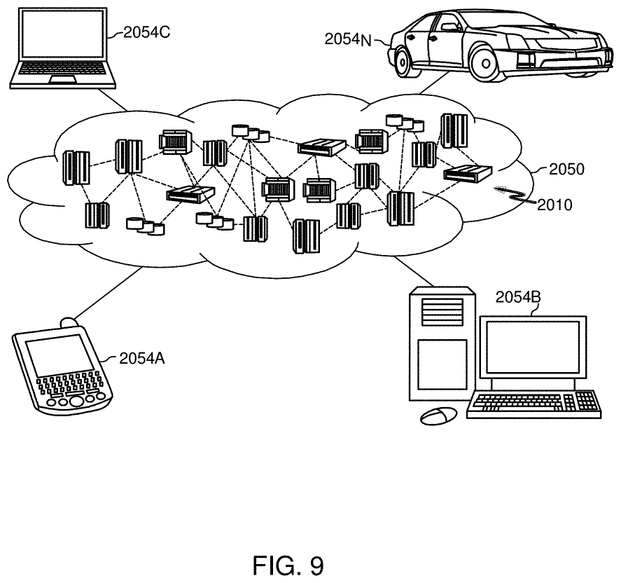

Referring now to FIG. 9, illustrative cloud computing environment 2050 is depicted.

As shown, cloud computing environment 2050 includes one or more cloud computing nodes 2010 with which local computing devices used by cloud consumers, such as, for example, personal digital assistant (PDA) or cellular telephone 2054A, desktop computer 2054B, laptop computer 2054C, and/or automobile computer system 2054N may communicate. Nodes 2010 may communicate with one another. They may be grouped (not shown) physically or virtually, in one or more networks, such as Private, Community, Public, or Hybrid clouds as described hereinabove, or a combination thereof. This allows cloud computing environment 2050 to offer infrastructure, platforms and/or software as services for which a cloud consumer does not need to maintain resources on a local computing device. It is understood that the types of computing devices 2054A-N shown in FIG. 9 are intended to be illustrative only and that computing nodes 2010 and cloud computing environment 2050 can communicate with any type of computerized device over any type of network and/or network addressable connection (e.g., using a web browser).

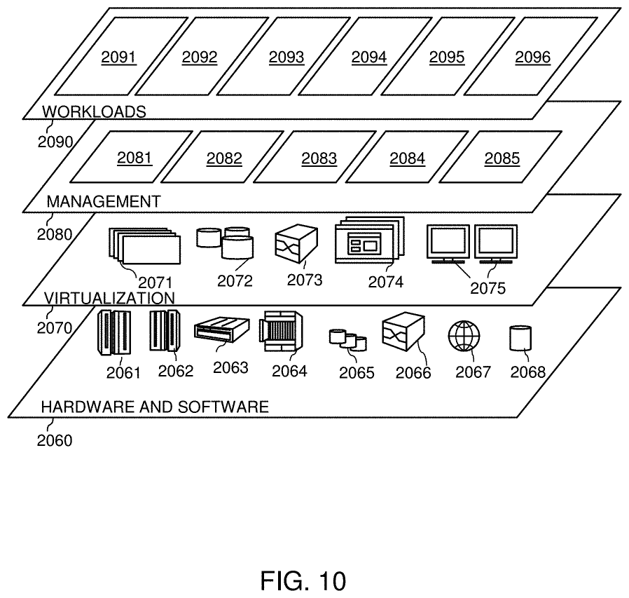

Referring now to FIG. 10, a set of functional abstraction layers provided by cloud computing environment 2050 (FIG. 9) is shown. It should be understood in advance that the components, layers, and functions shown in FIG. 10 are intended to be illustrative only and embodiments of the invention are not limited thereto. As depicted, the following layers and corresponding functions are provided:

Hardware and software layer 2060 includes hardware and software components. Examples of hardware components include: mainframes 2061; RISC (Reduced Instruction Set Computer) architecture based servers 2062; servers 2063; blade servers 2064; storage devices 2065; and networks and networking components 2066. In some embodiments, software components include network application server software 2067 and database software 2068.

Virtualization layer 2070 provides an abstraction layer from which the following examples of virtual entities may be provided: virtual servers 2071; virtual storage 2072; virtual networks 2073, including virtual private networks; virtual applications and operating systems 2074; and virtual clients 2075.

In one example, management layer 2080 may provide the functions described below. Resource provisioning 2081 provides dynamic procurement of computing resources and other resources that are utilized to perform tasks within the cloud computing environment. Metering and Pricing 2082 provide cost tracking as resources are utilized within the cloud computing environment, and billing or invoicing for consumption of these resources. In one example, these resources may include application software licenses. Security provides identity verification for cloud consumers and tasks, as well as protection for data and other resources. User portal 2083 provides access to the cloud computing environment for consumers and system administrators. Service level management 2084 provides cloud computing resource allocation and management such that required service levels are met. Service Level Agreement (SLA) planning and fulfillment 2085 provide pre-arrangement for, and procurement of, cloud computing resources for which a future requirement is anticipated in accordance with an SLA.

Workloads layer 2090 provides examples of functionality for which the cloud computing environment may be utilized. Examples of workloads and functions which may be provided from this layer include: mapping and navigation 2091; software development and lifecycle management 2092; virtual classroom education delivery 2093; data analytics processing 2094; transaction processing 2095; and transforming machine learning models to classify data samples outside of initially-established classes 2096.

The descriptions of the various embodiments of the present invention have been presented for purposes of illustration, but are not intended to be exhaustive or limited to the embodiments disclosed. Likewise, examples of features or functionality of the embodiments of the disclosure described herein, whether used in the description of a particular embodiment, or listed as examples, are not intended to limit the embodiments of the disclosure described herein, or limit the disclosure to the examples described herein. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A computer implemented method of transforming a machine learning model, comprising:
receiving by a computer, from a model source available to the computer, a first Machine Learning model trained to assign one of a first set of classes to received data samples based, at least in part on sets of feature group values associated with each of the data samples;
receiving by the computer from a data source available to the computer, a first set of data samples each characterized by an associated set of feature group values and assigned to one the first set of classes in accordance, at least in part, therewith;
calculating, by the computer for each of the first set of data samples, a vector representing a respective set of feature group values associated with each data sample and determining, for each of the first set of classes, a largest class sample distance between all of the first set of data samples assigned to the class;
generating, by the computer, a second set of data samples each characterized by a set of feature group values for which an associated calculated vector has an associated smallest distance from all other data samples in the first set of data samples exceeding all of the largest class sample distances and assigning each of the second set of data samples to one of a second set of classes each different from the first set of classes; and
transforming, by the computer, the first Machine Learning model into a second Machine Learning model by training the first Machine Learning model with training data including second set data samples labeled with associated second data class assignments.

2. The method of claim 1, further including, responsive to receiving a third set of data samples having a quantity above a predetermined threshold for which an associated calculated vector has an associated smallest distance from all other data samples in the first and second sets of data samples that exceeds all of the largest class sample distances, initiating by the computer, at least one corrective action.

3. The method of claim 2, wherein the at least one corrective action includes sending an alert to a user interface operatively connected to the computer.

4. The method of claim 2, wherein the at least one corrective action comprises:
assigning each of the third set of data samples to one of a third set of classes each different from the first and second sets of classes; and
transforming, by the computer, the second ML model into a third ML model by training the second ML with training data including third set data samples labeled with associated third data class assignments.

5. The method of claim 1, wherein the second set of classes includes a maximum quantity of classes based, at least in part on a second class quantity maximum value received by the computer from a quantity maximum value source available to the computer.

6. The method of claim 1, wherein the class sample distances are calculated based on a measurement technique selected from the group consisting of Euclidean distance, dot product, and cosine similarity.

7. The method of claim 1, wherein the feature group values are generated, at least in part, by application of a binning operation to a feature characterized by a substantially-continuous range.

8. A system to transform a machine learning model, which comprises:
a computer system comprising a computer readable storage medium having program instructions embodied therewith, the program instructions executable by a computer to cause the computer to:
receive from a model source available to the computer, a first Machine Learning model trained to assign one of a first set of classes to received data samples based, at least in part on sets of feature group values associated with each of the data samples;
receive from a data source available to the computer, a first set of data samples each characterized by an associated set of feature group values and assigned to one the first set of classes in accordance, at least in part, therewith;
calculate for each of the first set of data samples, a vector representing a respective set of feature group values associated with each data sample and determining, for each of the first set of classes, a largest class sample distance between all of the first set of data samples assigned to the class;
generate a second set of data samples each characterized by a set of feature group values for which an associated calculated vector has an associated smallest distance from all other data samples in the first set of data samples exceeding all of the largest class sample distances and assigning each of the second set of data samples to one of a second set of classes each different from the first set of classes; and
transform the first Machine Learning model into a second Machine Learning model by training the first Machine Learning model with training data including second set data samples labeled with associated second data class assignments.

9. The system of claim 8, further including instructions causing the computer to, in response to receiving a third set of data samples having a quantity above a predetermined threshold for which an associated calculated vector has an associated smallest distance from all other data samples in the first and second sets of data samples that exceeds all of the largest class sample distances, initiate at least one corrective action.

10. The system of claim 9, wherein the at least one corrective action includes sending an alert to a user interface operatively connected to the computer.

11. The system of claim 9, wherein the at least one corrective action comprises:
assigning each of the third set of data samples to one of a third set of classes each different from the first and second sets of classes; and
transforming, by the computer, the second ML model into a third ML model by training the second ML with training data including third set data samples labeled with associated third data class assignments.

12. The system of claim 8, wherein the second set of classes includes a maximum quantity of classes based, at least in part on a second class quantity maximum value received by the computer from a quantity maximum value source available to the computer.

13. The system of claim 8, wherein the class sample distances are calculated based on a measurement technique selected from the group consisting of Euclidean distance, dot product, and cosine similarity.

14. The system of claim 8, wherein the feature group values are generated, at least in part, by application of a binning operation to a feature characterized by a substantially-continuous range.

15. A computer program product to transform a machine learning model, the computer program product comprising a computer readable storage medium having program instructions embodied therewith, the program instructions executable by a computer to cause the computer to:
receive, using the computer, from a model source available to the computer, a first Machine Learning model trained to assign one of a first set of classes to received data samples based, at least in part on sets of feature group values associated with each of the data samples;
receive, using the computer, from a data source available to the computer, a first set of data samples each characterized by an associated set of feature group values and assigned to one the first set of classes in accordance, at least in part, therewith;
calculate, using the computer, for each of the first set of data samples, a vector representing a respective set of feature group values associated with each data sample and determining, for each of the first set of classes, a largest class sample distance between all of the first set of data samples assigned to the class;
generate, using the computer, a second set of data samples each characterized by a set of feature group values for which an associated calculated vector has an associated smallest distance from all other data samples in the first set of data samples exceeding all of the largest class sample distances and assigning each of the second set of data samples to one of a second set of classes each different from the first set of classes; and
transform, using the computer, the first Machine Learning model into a second Machine Learning model by training the first Machine Learning model with training data including second set data samples labeled with associated second data class assignments.

16. The computer program product of claim 15, further including instructions causing the computer to, in response to receiving a third set of data samples having a quantity above a predetermined threshold for which an associated calculated vector has an associated smallest distance from all other data samples in the first and second sets of data samples that exceeds all of the largest class sample distances, initiate at least one corrective action.

17. The computer program product of claim 16, wherein the at least one corrective action comprises:
assigning each of the third set of data samples to one of a third set of classes each different from the first and second sets of classes; and
transforming, by the computer, the second ML model into a third ML model by training the second ML with training data including third set data samples labeled with associated third data class assignments.

18. The computer program product of claim 15, wherein the second set of classes includes a maximum quantity of classes based, at least in part on a second class quantity maximum value received by the computer from a quantity maximum value source available to the computer.

19. The computer program product of claim 15, wherein the class sample distances are calculated based on a measurement technique selected from the group consisting of Euclidean distance, dot product, and cosine similarity.

20. The computer program product of claim 15, wherein the feature group values are generated, at least in part, by application of a binning operation to a feature characterized by a substantially-continuous range.
